(19) United States
(12) Patent Application Publication
(10) Pub. No.: US 2014/0279133 A1
(43) Pub. Date: Sep. 18, 2014

(54) FAULT TOLERANT COMBINATORIAL AUCTIONS FOR TASKS HAVING TIME AND PRECEDENCE CONSTRAINTS WITH BONUSES AND PENALTIES

(71) Applicant: XEROX CORPORATION, Norwalk, CT (US)

(72) Inventors: Haengju Lee, Webster, NY (US); Yu-An Sun, Webster, NY (US)

(73) Assignee: XEROX CORPORATION, Norwalk, CT (US)

(21) Appl. No.: 13/796,573

(22) Filed: Mar. 12, 2013

(51) Int. Cl. G06Q 30/08

(52) U.S. Cl. CPC G06Q 30/08
USPC 705/26.3

(57) ABSTRACT

There is disclosed a method of conducting an auction under execution uncertainty to satisfy incentive compatibility, individual rationality, and efficiency by leveraging bonuses and penalties. A buyer posts a task including multiple sub-tasks. The buyer specifies temporal and precedence relationships among the sub-tasks. The buyer also specifies the time interval for the sub-tasks. Suppliers submit bids including their interested sub-tasks, prices, and proposed schedules. A winner determination problem is formulated based on bid prices, suppliers' success probabilities in delivering the sub-tasks, and the suppliers' schedules of undertaking sub-tasks. Having decided the winners, suppliers who delivered with success will be granted bonuses and those who were not able to deliver will be imposed penalties. The bonuses and penalties are formulated under a verification assumption. The combinatorial mechanism using the formulated winner determination rule and payment rule including bonuses and penalties satisfy economic properties such as incentive compatibility, individual rationality, and efficiency.

### BACKGROUND

The present inventive subject matter relates generally to the art of combinatorial auctions. Particular but not exclusive relevance is found in connection with an on-demand service marketplace platform suitable for conducting fault tolerant combinatorial auctions for tasks having time and precedence constraints with bonuses and penalties. The present specification accordingly makes specific reference thereto at times. However, it is to be appreciated that aspects of the present inventive subject matter are also equally amenable to other like applications.

When a buyer, for example, has a task that is made up of multiple nonhomogeneous sub-tasks to outsource, a supplier (i.e., a bidder) may propose an overall price for a combination of sub-tasks which is lower than the sum of prices they would propose for each of the sub-tasks individually. To capture this difference, combinatorial auctions generally allow bidders to submit bids on a combination or bundle of sub-tasks. Combinatorial auctions have been provided in an FCC (Federal Communication Commission) spectrum auctions, auctions for airport time slots, railroad segments, delivery routes, and network routing.

Manually conducting combinatorial auctions can be labor intensive and prone to human error. Accordingly, there is generally a desire to conduct such auctions automatically and/or electronically. For example, there is generally a desire for suppliers to have a common place whereby they can come together to offer their services to meet a buy's request. Buyers likewise can benefit from competitive bidding and would in some cases like to have a reliable and accurate mechanism for identifying and/or determining winning bids consistent with economic properties, e.g., such as incentive compatibility, individual rationality and efficiency.

In combinatorial auctions (e.g., especially procurement auctions), it is generally desirable to consider multiple attributes and/or parameters when determining winning bids. For example, the attributes that a buyer may generally consider noteworthy include price, reliability or reputation of bidders, schedule of bidders, etc. However, some prior works tend to deal mostly with price and may not address other attributes that may be of interest to a buyer. For example, the degree to which a buyer desires to have a task successfully complete may vary from task to task, and accordingly, the price they are willing to accept for confidence in the completion of any given task may vary accordingly. Therefore, a bidders reliability and/or reputation for successful completion of tasks becomes of particular interest.

Additionally, the sub-tasks of a given task may have time and/or precedence relationships therebetween, e.g., such that one sub-task cannot be successfully completed if another is not successfully completed beforehand. Some prior works do not account for such constraints and may not be able to identify winning bids which meet the criteria.

Moreover, it may be desirable to influence the behavior of suppliers, e.g., with a system of rewards or bonuses and/or penalties. That is to say, bonuses (e.g., in the form of additional payment or compensation) can tend to encourage suppliers to complete awarded tasks, and penalties can conversely discourage suppliers from not completing awarded task. However, some prior works do not have a way to leverage such bonus incentives and/or penalty disincentives.

Accordingly, a new and/or improved method and/or system or apparatus for conducting combinatorial auctions is disclosed which addresses the above-referenced problem(s) and/or others.

### SUMMARY

This summary is provided to introduce concepts related to the present inventive subject matter. The summary is not intended to identify essential features of the claimed subject matter nor is it intended for use in determining or limiting the scope of the claimed subject matter. The embodiments described below are not intended to be exhaustive or to limit the invention to the precise forms disclosed in the following detailed description. Rather, the embodiments are chosen and described so that others skilled in the art may appreciate and understand the principles and practices of the present inventive subject matter.

In accordance with one embodiment, a method is provided for conducting an auction. The method includes: obtaining a task and a valuation therefor submitted by a buyer, the task being defined by a plurality of sub-tasks, a set of precedence relationships specified between the sub-tasks, and a designated start time for the task and a designated end time for the task corresponding to an interval in which the task is to be completed; obtaining one or more bids associated with the task from one or more suppliers, each supplier submitting one or more of the bids and each bid identifying (i) a set of the sub-tasks for which the bid is being submitted, (ii) a proposed price for each individual sub-task in the identified set thereof and (iii) for each particular sub-task in the identified set, a schedule including a proposed start time range in which the supplier submitting the bid proposes to begin the particular sub-task in the identified set and a duration in which the supplier submitting the bid proposes to complete the particular sub-task; determining a probability of each supplier successfully completing each sub-task for which they submitted a bid; and identifying one or more winning bids from the obtained bids based on the proposed prices of the bids, the determined success probabilities and the proposed schedules of the bids, the winning bids satisfying constraints of the task.

In accordance with another embodiment, a system is provided including a data processor operative to execute the foregoing method.

Numerous advantages and benefits of the inventive subject matter disclosed herein will become apparent to those of ordinary skill in the art upon reading and understanding the present specification. It is to be understood, however, that the detailed description of the various embodiments and specific examples, while indicating preferred and other embodiments, are given by way of illustration and not limitation. Many changes and modifications within the scope of the present invention may be made without departing from the spirit thereof, and the invention includes all such modifications.

### BRIEF DESCRIPTION OF THE DRAWING(S)

The following detailed description makes reference to the figures in the accompanying drawings. However, the inventive subject matter disclosed herein may take form in various components and arrangements of components, and in various steps and arrangements of steps. The drawings are only for purposes of illustrating exemplary and/or preferred embodiments and are not to be construed as limiting. Further, it is to be appreciated that the drawings may not be to scale.

FIG. 1 is a diagrammatic illustration showing an exemplary system suitable for conducting a combinatorial auction in accordance with one or more aspects of the present inventive subject matter.

FIG. 2 is a diagrammatic illustration showing an exemplary task including a set of sub-tasks having time and/or precedence relationships among the sub-task, which task is suitable for practicing one or more aspects of the present inventive subject matter.

FIG. 3 is a flow chart showing an exemplary method, algorithm and/or process by which a combinatorial auction may be conducted in accordance with one or more aspects of the present inventive subject matter.

### DETAILED DESCRIPTION OF THE EMBODIMENT(S)

For clarity and simplicity, the present specification shall refer to structural and/or functional elements, relevant standards, algorithms and/or protocols, and other components, algorithms, methods and/or processes that are commonly known in the art without further detailed explanation as to their configuration or operation except to the extent they have been modified or altered in accordance with and/or to accommodate the preferred and/or other embodiment(s) presented herein. Moreover, the systems, apparatuses, processes, algorithms and methods disclosed in the present specification are described in detail by way of examples and with reference to the figures. Unless otherwise specified, like numbers in the figures indicate references to the same, similar or corresponding elements throughout the figures. It will be appreciated that modifications to disclosed and described examples, arrangements, configurations, components, elements, apparatuses, methods, algorithms, materials, etc. can be made and may be desired for a specific application. In this disclosure, any identification of specific materials, techniques, arrangements, etc. are either related to a specific example presented or are merely a general description of such a material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to the figures.

With reference generally to FIG. 1, there is disclosed herein is an on-demand service marketplace platform 10 and/or other like system, e.g., provided and/or supported by a server 12 and/or other suitable data processor. Suitably, the server 12 and/or other suitable data processer is provisioned and/or equipped to execute a method, algorithm and/or process, e.g., such as the method, algorithm and/or process 100 illustrated in FIG. 3. The platform/system 10 provides a place for a plurality of suppliers to come together (e.g., optionally in real or near-real time) to offer their services to meet a buyer's request, e.g., for goods and/or services.

In practice, the marketplace platform 10 supports, runs, conducts and/or administers a combinatorial auction, where a buyer submits a task made up, e.g., of a plurality of sub-task, and where one or more bidders (i.e., suppliers) submit one or more bids for a bundle or combination of one or more of the sub-tasks. As shown, the buyer may submit the task to the server 10 via a terminal 14 (e.g., such as a computer or the like operatively connected to and/or otherwise in communication with the server 12), and the suppliers may submit their bid to the server 10 via terminals 16 (e.g., such as a computer or the like operatively connected to and/or otherwise in communication with the server 12).

In one suitable embodiment, the combinatorial auction conducted by the system or platform 10 is especially applicable to procurement auctions, and multiple attributes and/or parameters are taken into consideration (e.g., by the server 12) to determine winning bids, e.g., which attributes and/or parameters would be generally of interest to the buyer. These attributes and/or parameters may include, without limitation: the proposed prices for sub-task within the bids; the reliability and/or reputations of the bidders/suppliers; and/or the proposed schedules of the bidders/suppliers.

As shown, the platform 10 and/or server 12 includes and/or has access to a reputation database (DB) 18 or other like system. Suitably, the DB 18 contains reputation and/or reliability ratings or rankings for the various suppliers submitting bids, which reflect or represent the past or historical performance of the respective suppliers with respect to delivering and/or successfully completing tasks or sub-tasks. That is to say, suitably, the reputation and/or reliability ratings or rankings stored and/or maintained in the DB 18 track and/or record past performances of suppliers regarding the successful delivery and/or completion of previously awarded tasks or sub-tasks. For example, relatively higher ratings or ranks correspond to a relatively greater success rate or greater probability of task or sub-task completion, while conversely relatively lower ratings or ranks correspond to a relatively lower success rate or lower probability of task or sub-task completion. In practice, the ratings and/or rankings from the DB 18 are suitably employed, e.g., by the server 12, in determining the winning bids.

To illustrate, consider, for example, a buyer that thinks that the reputation of a bidder is twice as important as bid price; or consider a buyer has a task which is they feel is very important to accomplish. In these cases, the buyer may tend to be willing to pay more for a task or sub-task to a more reliable bidder, e.g., to avoid a risk of failure and/or to increase the probability of successful delivery of the assigned task or sub-task. Accordingly, reputation rankings or ratings or the like (e.g., stored and/or maintained in a reputation database (DB) 12) are translated into the reliability of suppliers, and in turn this can be used to reflect the probability of a supplier delivering a promised task, i.e., with higher reliability and/or reputation ratings corresponding to increased confidence in a successful completion of the task by the supplier. Therefore, in accordance with one suitable embodiment disclosed herein, the entity operating the combinatorial auction (e.g., via the platform 10 and/or server 12) has access to the aforementioned reputation DB 18 or another like reputation system and the probability of a supplier performing a given task is derived therefrom.

In addition, suitably, the buyer submits a task that can be broken down into multiple sub-tasks with time and precedence relationships. Accordingly, the winning bids (e.g., selected by the server 12) satisfy the applicable constraints. In other word, in accordance with one suitable embodiment, a winner determination problem of the combinatorial auction as defined and/or otherwise established herein satisfies the time and/or precedence constraints while minimizing the overall risk and cost of completing the submitted task.

In accordance with one embodiment, there are several goals that the combinatorial auction conducted and/or administered by the platform or system 10 aims to pursue, e.g., including, without limitation: 1) incentive compatibility, 2) individual rationality, and 3) economic efficiency. In accordance herewith, a combinatorial mechanism is disclosed that satisfies those properties by leveraging bonuses and penalties, e.g., for completion and non-completion of sub-tasks, respectively.

In auctions, multiple participants (a buyer and sellers) with different interests are interacting to acquire their best deal. Therefore, to analyze and predict auction outcomes, it suffices to rely on or employ the game theory or interactive decision theory. Assuming all participants “play” their best responses which maximize their utilities, then the next consideration is whether or not there is an equilibrium point from which no one wants to deviate. Given a showing that the auction mechanism is incentive compatible, then a supplier bidding simply his cost (e.g., in the case of procurement auctions) is a strategic bid, and honest bidding provides an equilibrium point. Furthermore, the auction satisfies the goal of individual rationality if the expected utility of each bidder is non-negative when his bidding strategy is truthful. Finally, the auction is economic efficient when the auction maximizes the sum of expected utilities (referred to as the social welfare) of all the participants.

In the on-demand service marketplace disclosed herein, a buyer posts a task composed of multiple sub-tasks to be outsourced. If there are time and/or precedence relationships among the sub-tasks, then the buyer also specifies those relationships. The precedence relationships can be expressed visually as shown in FIG. 2. Sub-task 2 or 3 can be attempted only after sub-task 1 is completed with success. Similarly, sub-task 4 can be attempted only when sub-tasks 1, 2, and 3 are completed with success. The buyer may also specify a time interval within which all the sub-tasks should start and finish. The system 10 enables all the bidders to choose any set of sub-tasks in their interest and lets them submit prices for those selected sub-tasks. Suitably, the buyer pays for the sub-tasks which were attempted and have been delivered with success. Accordingly, the system 10 lets each bidder submit bid prices for all the sub-tasks that he has selected. For example, if a bidder selects sub-task 1 and sub-task 2, then he submits a bid price for sub-task 1 and a bid price of sub-task 2 instead of the total bid price of the two sub-tasks. Suitably, for example, if a supplier attempted sub-task 1 and delivered it with success but failed in delivering sub-task 2, then he still gets paid for sub-task 1 even though he is not paid for sub-task 2. For this reason, the system 10 acquired or obtains each individual bid price for respective sub-tasks instead of merely the total bid price for the combination of sub-tasks. In addition, the task may have precedence relationships and a time interval for completing all the sub-tasks. Therefore, each bidder is prompted to present or provide time schedules specifying an available range of time in which they propose to start selected sub-tasks and the durations in which they propose to complete them.

In one exemplary embodiment, the bidding language employed is XOR bid, but alternately other bidding languages be used without loss of generality. In the XOR bid language, each bidder is allowed to submit multiple bids, but suitably, at most one bid from those submitted multiple bids will be chosen per bidder. For this reason, each bidder should submit all the possible combinations of sub-tasks that he is interested in undertaking. In practice, each bidder submits one or more XOR bids containing his selected sub-tasks, the proposed prices of the sub-tasks, and his proposed schedules for starting and completing the sub-tasks. After collecting all the bids, e.g., during a selected or otherwise designate or determined auction period, the formulated winner determination problem described herein is used selected and/or identify winning bids based on, e.g., the bid prices, the bidders' success probabilities in delivering the sub-tasks, and the bidders' proposed schedules for undertaking the sub-tasks. In general, the trustworthiness of the bidders as well as prices are considered in determining winning bids. Accordingly, to be selected in the winning bids, a bidder generally submits a low bid price when his trustworthiness score is low. In other words, the buyer is willing to pay more to more trusted suppliers to avoid a risk of failure of their task. In addition, the buyer generally desires feasibility of their task when all the bids are collected and seeks an optimal set of bids in the feasible solution domain. Accordingly, these factors have been considered in formulating the winner determination problem described. Having decided the winners, a formulated payment rule as described herein is applied including bonuses which are to be granted when the awarded and/or promised sub-tasks are completed with success and penalties which are to be imposed when the awarded and/or promised sub-tasks are not completed or completed with failure. Suitably, the bonuses and penalties are accommodated in the payment to give a strong motivation to accomplish the delivery of the final successful task. It is shown herein that an assignment rule based on the herein described formulated winner determination problem and the payment rule based on the formulated bonuses and penalties lead the auction mechanism to satisfy incentive compatibility, individual rationality, and economic efficiency under a verification assumption which will be explained below.

The combinatorial auctions conducted and or administered by the system 10 described herein are applicable to the case where sub-tasks have temporal and precedence relationships and where there are bonuses and penalties applied for assigned sub-tasks. The formulated payment rule including bonuses and penalties and applied assignment rule with a temporal and precedence constraints satisfy incentive compatibility, individual rationality, and economic efficiency under the aforementioned verification assumption. In addition, the winner determination problem formulated is applicable for the case of multiple XOR bids, e.g., as opposed to merely a single atomic bid.

The description hereinafter is organized as follows. In section 1, there is described a suitable bidding language for a buyer and multiple bidders. Next, a suitable winner determination problem is formulated in section 2, and a suitable payment rule is formulated in section 3. The mathematical theorems and mathematical proofs illustrating satisfaction of incentive compatibility, individual rationality, and economic efficiency are also presented in section 3. Also covered in section 3 is the payment bound of the payment method. Conclusions are presented in section 4.

### I. BIDDING LANGUAGE FOR A BUYER AND BIDDERS

### A. Bidding Language for a Buyer

In one suitable embodiment, a buyer submits or posts a task τ on the on-demand service marketplace 10 composed of t numbers of sub-tasks such as τ={s₁, . . . , sₜ} and a set of precedence relationships denoted as Γ, wherein sᵢ represents the i^{th} sub-task. For example, as shown in FIG. 2, the precedence relationships are s₁<(s₂, s₃)<s₄. The buyer may specify a start time of the task denoted as T_{begin} and an end time denoted as T_{end}. Therefore, the sub-tasks should be located between T_{begin} and T_{end} while satisfying all the precedence relations in Γ.

Because there is uncertainty in task and/or sub-task execution, a valuation thereof to the buyer is also uncertain. Assume that their valuation is V if all the sub-tasks are delivered with success and that it is zero otherwise. The valuation has a stochastic property depending on the execution of each sub-task. Two possible case are considered. In the first case, the buyer has some valuation for the partially completed work. The partial valuation will play a role of a task level reserve price because the bid price higher than the expected valuation is not proper for the buyer. In the second case, the buyer only has the valuation for all the completed work and does not have or does not know the partial valuations. Note that suitable the valuation V is a public knowledge, so all the bidders are aware of the value.

1) Task level reserve price: The buyer may present, submit and/or provide a set of valuation V=(V₁, V₂, . . . , Vₜ) for all the sub-tasks (e.g., to the server 12 along with task), where Vᵢ represents the valuation of sub-task Sᵢ that the buyer obtains when sᵢ completed with success. V also plays a role of the reserve price of sᵢ, which means that the buyer only accepts bids whose prices are not more than the expected valuation of sᵢ. Assume that there is a bid whose bid price is bᵢ and the probability of success ism for a supplier. The expected valuation of the buyer about the suppler undertaking sᵢ is Vᵢpᵢ, so the bid is accepted only when bᵢ<Vᵢpᵢ.

2) No task level reserve price: The buyer may have no residual valuation of some partial completion of task τ. Accordingly, they has a valuation V only when all the sub-tasks in τ are completed with success.

### B. Bidding Language for Bidders

Assume that there are n numbers of bidders. The bidder jε{1, . . . , n} can submit a multiple number of XOR bids and the number is denoted as N^{j}. In XOR bidding, suitably, at most one bid among the N^{j} bids will be selected in a winning bid set. In practice, the bidder j submits a bid bⱼ=(Sⱼ₁, bⱼ₁, Tⱼ₁)⊕(Sⱼ₂, bⱼ₂, Tⱼ₂)⊕ . . . ⊕(S_{jN}_{^{j}}, b_{jN}_{^{j}}, T_{jN}_{^{j}}), where Sⱼₖ represents the set of sub-tasks, and bⱼₖ represents the set of bid prices of Sⱼₖ. Suitably, all the individual bid prices for each sub-task are submitted because there is a possibility that some sub-tasks are done with success and some are not. In general, the buyer will be responsible for paying for the sub-tasks finished with success. Tⱼₖ represents the bidder's schedule in the form of {(eⱼₖⁱ, kⱼₖⁱ, dⱼₖⁱ)}, where eⱼₖⁱ represents an early start time, fⱼₖⁱ represents a late start time, and dⱼₖⁱ represents a duration of task sᵢ if sᵢεSⱼₖ. For each sᵢ and bidder j, there is a corresponding probability of success pᵢⱼ that is maintained and updated by the reputation system (e.g., in the DB 18). Next, there is discussed a suitable formation of the winner determination problem using the bids collected based on the described bidding language.

### II. WINNER DETERMINATION PROBLEM

When the problem is formulated, the following assumptions are made for a simple expression of the equations. However, alternatively, the problem can be extended to a more general case with interrelated probabilities.

Assumption 1: The probability of success of each sub-task is independent with respect to those of other sub-tasks.

Assumption 2: The buyer and bidders are rational and risk-neutral, i.e., in general, they all maximize their own utilities which are the expected payoff. The decision variable for the winner determination problem is yⱼₖ which is associated with the k^{th} bid of bⱼ. Suitably, the value of yⱼₖ is one (1) when the k^{th} bid of bj is selected as a winning bid and zero (0) otherwise. To track the precedence relationships, a variable lⱼₖⁱ is also used, which represents the start time of sub-task sᵢ in the k^{th} bid of bⱼ. Let prec(i) represent the set of all the sub-tasks which should be done before sᵢ which can be obtained from the precedence relationships F. For example, prec(1)=φ, prec(2)=prec(3)={s₁}, and prec(4)={s₁, s₂, s₃} in FIG. 2.

### A. Objective Function

1) Task level reserve price: The objective function which is maximized can be formulated as follows:

$$Maximize {\sum }_{i = 1}^{t} {V}_{i} {P}_{i} {p}_{i} - {\sum }_{i = 1}^{t} {b}_{i} {p}_{i} , \\ where$$

$${b}_{i} = {\sum }_{j = 1}^{n} {\sum }_{k = 1}^{{N}^{j}} {b}_{jk}^{i} {a}_{jk}^{i} {y}_{jk} , \\ {p}_{i} = {\sum }_{j = 1}^{n} {\sum }_{k = 1}^{{N}^{j}} {p}_{ij} {a}_{jk}^{i} {y}_{jk} , \\ {P}_{i} = {{\prod }_{{i}^{′} {pi}^{′} .}}^{ }$$

bᵢ is the bidding price of the task sᵢ under the assignment rule {yⱼₖ}. For bidder j, if the k^{th} bid of his is selected as a winning bid (i.e., yⱼₖ=1) and sᵢ is in Sⱼₖ (i.e., aⱼₖⁱ=1), then bᵢ is bⱼₖⁱ. pᵢ is the probability of success of sᵢ under the assignment rule {yⱼₖ}, which can be explained in a similar way as bᵢ. Pᵢ is the probability that all the sub-tasks preceding sᵢ are done with success and is the product of all the success probabilities in prec(i) due to the independent Assumption 1 above.

The objective function represents the expected social welfare of the truthful combinatorial auction by Assumption 2 above. The expected payoff of the buyer is the expected valuation minus the expected total payments to all the winning bidders. Likewise, the expected payoff of a bidder is the expected payment from the buyer minus the expected cost of undertaking the assigned sub-tasks. Therefore, the expected social welfare is the sum of payoffs of all the participants including the buyer and the bidders, which is the expected valuation minus the expected cost of undertaking the assigned sub-tasks. The buyer has the valuation Vᵢ if sᵢ is attempted and delivered with success, which can happen when all the preceding sub-tasks of it are delivered with success and s₁ is also delivered with success. The probability of the occurrence is Pᵢ·pᵢ under the assignment rule {yⱼₖ}. sᵢ is attempted with a cost when all the preceding tasks of it are delivered with success whose probability is Pᵢ. Because the buyer does not have information about the actual costs of bidders ex ante, the bid price bᵢ replaces the actual cost of sᵢ under the assignment rule {yⱼₖ}. However, because one goal is to have an incentive compatible auction (i.e., the bid price is equal to the actual cost), the formulated objective function coincides with the social welfare.

2) No task level reserve price: If there is no task level individual valuation, and the buyer expects the valuation of V only when all the sub-tasks are delivered with success, then a modification from the previous formulation for the task level reserve price involves the expected valuation part. The probability of having the valuation V is the product of all the success probabilities of sub-tasks under the assignment rule {yⱼₖ}. Accordingly, the modified objective function is

$$Maximize {\sum }_{i = 1}^{t} {p}_{i} \cdot V - {\sum }_{i = 1}^{t} {b}_{i} {p}_{i} .$$

### B. Constraints

In one exemplary embodiment, constraints are developed to handle the case of XOR bids as follows.

The first constraint is for the bid selection variable yⱼₖ. The value of it is one (1) if the k^{th} bid of bidder j is a winning bid and is zero (0) otherwise. This constraint can be expressed as:

yⱼₖε{0,1}, for all jε{1, . . . , n},kε{1, . . . , N^{j}}.

The second constraint is the start time limitation for each sub-task. The start time of sᵢ (i.e., lⱼₖⁱ) is between the earliest possible start time (i.e., eⱼₖⁱ) and the latest possible start time (i.e., fⱼₖⁱ) if sᵢ is in Sⱼₖ. This constraint can be expressed as follows:

eⱼₖⁱ≦lⱼₖⁱ≦fⱼₖⁱ for all aⱼₖⁱ=1,jε{1, . . . , n},kε{1, . . . ,N^{j}}.

The third constraint is the coverage of task. To satisfy this constraint, all the sub-task should be selected by the assignment rule {yⱼₖ}. This constraint can be expressed as follows:

$${\sum }_{j = 1}^{n} {\sum }_{k = 1}^{{N}^{j}} {a}_{jk}^{i} {y}_{jk} = 1 for all i ∈ \{ 1 , … , t \}$$

The fourth constraint is for the XOR bids. Suitably, to satisfy this constraint, at most one bid among multiple bids from a bidder is selected. This constraint can be expressed as follows:

$${\sum }_{k = 1}^{{N}^{j}} {y}_{jk} \leq 1 , j ∈ \{ 1 , … , n \} .$$

The fifth constraint is to check the feasibility of temporal and precedence relations. That is, if sᵢ is in Sⱼₖ, s_{i′} is in S_{j′k′}, and s_{i′} should be done before sᵢ, then the start time of sᵢ (i.e., lⱼₖⁱ) should be later than the start time of s_{i′} plus the duration of s_{i′} (i.e. l_{j′k′}^{i′}+d_{j′k′}^{i′}) if yⱼₖ=y_{j′k′}=1. M is a big number and is used to make the below constraints satisfied when yⱼₖ=0 or y_{j′k′}=0. Moreover, the start time of sᵢ should be later than T_{begin} and the end time of sᵢ should be earlier than T_{end} if yⱼₖ=1. This constraint can be expressed as follows:

lⱼₖⁱ≧l_{j′k′}^{i′}+d_{j′k′}^{i′}−M(2−yⱼₖ−y_{j′k′}),

lⱼₖⁱ≧T_{begin}−M(1−yⱼₖ),

lⱼₖⁱ+dⱼₖⁱ≦T_{end}+M(1−yⱼₖ),

for all aⱼₖⁱ=a_{j′k′}^{i′}=1 and s_{i′}εprec(i),

j,j′ε{1, . . . , n},kε{1, . . . , N^{j}},k′ε{1, . . . , N^{j′}}.

### III. PAYMENT RULE

In this section, the aforementioned verification assumption is imposed on the cost of supplier. For example, suitably, this verification assumption can be realized when the buyer discovers the true cost of the winning supplier either through additional investigation or auditing the cost structure of the supplier when jobs are delivered.

Assumption 3: The buyer pays or is responsible to pay the supplier after the assigned sub-task is delivered with success. At the time, the buyer knows the actual cost of the supplier through investigation or auditing.

Let a*(b)=(a₁*(b), a₂*(b), . . . , aₜ*(b)) be an optimal allocation when bidding from n bidders is given by b={b₁, b₂, . . . , bₙ}. Therefore, aᵢ*(b) represents a supplier to whom s₁ is assigned. We also let g*(b)=(g₁*(b), . . . , gₜ*(b)) be a vector of bid prices of sub-tasks under the optimal allocation for a given bidding b. c_{i,a*}_{ᵢ}(b) is the actual cost of s₁ when it is completed by the supplier aᵢ*(b). β_{i,a*}_{ᵢ}(b) is the bonus to the supplier aᵢ*(b) when sᵢ is done with success. α_{i,a*}_{ᵢ}(b) is the penalty to the supplier aᵢ*(b) when sᵢ is done with failure. ρi,a*_{ᵢ}(b) is the probability of success of sᵢ under the optimal allocation, and Pᵢ*(b) is the probability that all the sub-tasks in prec(i) are successful under the optimal allocation. Note that

$${P}_{i}^{*} ( b ) = {\prod }_{{i}^{′} ∈ prec ( i )}^{ } {p}_{ {i}^{′} {a}_{{i}^{′}}^{*} ( b )} .$$

In a first part discussed below, we consider the payment rule including bonuses. The analysis is then extended to the payment rule including both bonuses and penalties in a second part discussed below.

A. Payment with Bonuses

The following shows all possible events for a payment including bonuses.

sᵢ is attempted and is successful, the supplier aᵢ*(b) receives the amount of c_{i,a*}_{ᵢ}_{(b)}+β_{i,a*}_{ᵢ}_{(b)} with probability P*ᵢ(b)·p_{i,a*}_{ᵢ}_{(b)}.

sᵢ is attempted and is unsuccessful, the supplier aᵢ*(b) does not receive any payment with probability P*ᵢ(b)·(1−p_{i,a*}_{ᵢ}_{(b)}).

sᵢ is not attempted, the supplier aᵢ*(b) does not receive any payment with probability 1−P*ᵢ(b).

The buyer receives the incremental benefit Vᵢ when sᵢ is completed under the task level reserve price. However, the benefit is zero when sᵢ is not the final sub-task and it is V when sᵢ is the final sub-task and is successful under no task level reserve price.

Accordingly, the optimal objective value is

$${W}^{*} ( b ) = {\sum }_{i = 1}^{t} {V}_{i} {P}_{i}^{*} ( b ) {p}_{i , {a}_{i}^{*} ( b )} - {\sum }_{i = 1}^{t} {g}_{i}^{*} * ( b ) {P}_{i}^{*} ( b ) .$$

Let f*ⱼ(b) be the set of sub-tasks assigned to the bidder j under the optimal allocation for a given bidding set b. If no sub-tasks are assigned to the agent j, then f*ⱼ*(b) is empty (i.e., f*ⱼ(b)=φ). We also let

$${\tilde{W}}_{j} ( b ) = {\sum }_{i = 1}^{t} {V}_{i} {P}_{i}^{*} ( b ) {p}_{i , {a}_{i}^{*} ( b )} - {\sum }_{i ∈ {f}_{j}^{*} ( b )}^{ } {c}_{i , j} {P}_{i}^{*} ( b ) - {\sum }_{i ∉ {f}_{j}^{*} ( b )}^{ } {g}_{i}^{*} ( b ) {P}_{i}^{*} ( b ) .$$

For bidder j, \tilde{W}ⱼ(b) is the value of the optimal objective value except that the bid prices of sub-tasks assigned to the bidder j are replaced by the actual costs. Note that the bidder j knows the value of \tilde{W}ⱼ(b) from the beginning of the auctions based on the knowledge of all the winning bid prices and his private knowledge of actual cost structures of assigned sub-tasks.

### Lemma 1: Bonus Function

Let the bonus of sᵢ to the supplier aᵢ*(b) be formulated as below.

$${β}_{i , {a}_{i}^{*} ( b )} = \frac{{x}_{i} {\tilde{W}}_{{a}_{i}^{*} ( b )} ( b )}{{P}_{i}^{*} ( b ) {p}_{i , {a}_{i}^{*} ( b )}} + \frac{( 1 - {p}_{i , {a}_{i}^{*} ( b )} ) {c}_{i , {a}_{i}^{*} ( b )}}{{p}_{i , {a}_{i}^{*} ( b )}} , \\ where$$

$${x}_{i} = \frac{{x}_{{a}_{i}^{*} ( b )}}{the number of subt - tasks assigned to {a}_{i}^{*}}$$

and X_{a*}_{ᵢ}_{(b)} is non-negative. Then the expected payoff of the supplier aᵢ*(b) for undertaking sᵢ is xᵢ\tilde{W}_{a*}_{ᵢ}_{(b)}(b).

Proof: The expected payoff denoted as u_{a*}_{ᵢ}_{(b)} is

$$\begin{matrix}{u}_{{a}_{i}^{*} ( b )} = {β}_{i , {a}_{i}^{*} ( b )} {P}_{i}^{*} ( b ) {p}_{i , {a}_{i}^{*} ( b )} - {c}_{i , {a}_{i}^{*} ( b )} {P}_{i}^{*} ( b ) ( 1 - {p}_{i , {a}_{i}^{*} ( b )} ) \\ = {x}_{i} {\tilde{W}}_{{a}_{i}^{*} ( b )} ( b ) + ( 1 - {p}_{i , {a}_{i}^{*} ( b )} ) {c}_{i , {a}_{i}^{*} ( b )} {P}_{i}^{*} ( b ) - {c}_{i , {a}_{i}^{*} ( b )} {P}_{i}^{*} ( b ) ( 1 - {p}_{i , {a}_{i}^{*} ( b )} ) \\ = {x}_{i} {\tilde{W}}_{{a}_{i}^{*} ( b )} ( b )\end{matrix}$$

### Theorem 1: Incentive Compatibility

In practice, being truthful is a best strategy for each bidder under the formulated assignment rule and payment rule with bonuses.

Proof: It will now be mathematically proven that in accordance herewith the expected payoff of the bidder j when he is truthful (i.e., the bid prices are actual costs) is greater than that when he is not truthful (i.e., the bid prices are not actual costs). Assume that the bid b′ consists of the bid prices of b except that the bid prices of bidder j are all the actual costs. He gets assigned the set of tasks f*ⱼ(b′) under the bid b′ and f*ⱼ(b) under the bid b. Assume that the expected payoff is Uⱼ(b′) under b′ and Uⱼ(b) under b. To mathematically prove the incentive compatibility, it suffices to show that Uⱼ(b′)≧Uⱼ(b). By Lemma 1,

$$\begin{matrix}{U}_{j} ( {b}^{′} ) = {\sum }_{i ∈ {f}_{j}^{*} ( {b}^{′} )}^{ } {x}_{i} {\tilde{W}}_{j} ( {b}^{′} ) \\ = {X}_{j} {\tilde{W}}_{j} ( {b}^{′} )\end{matrix} \\ \begin{matrix}{U}_{j} ( b ) = {\sum }_{i ∈ {f}_{j}^{*} ( b )}^{ } {x}_{i} {\tilde{W}}_{j} ( b ) \\ = {X}_{j} {\tilde{W}}_{j} ( b ) .\end{matrix} \qquad ( 1 )$$

\tilde{W}ⱼ(b′) is the objective value when the bidding is b′ and the assignment is f*(b′). \tilde{W}ⱼ(b′) is the objective value when the bidding is b and the assignment is f*(b). Because f*(b′) optimizes the objective value when the bidding is b′, we have

\tilde{W}ⱼ(b′)≧\tilde{W}ⱼ(b)

and

Uⱼ(b′)≧Uⱼ(b).

### Theorem 2: Individual Rationality

When the bidder is truthful, the expected payoff is non-negative.

Proof: The expected payoff of bidder j when he is truthful (see equation (1)) is given by

Uⱼ(b′)=Xⱼ\tilde{W}ⱼ(b′)=XⱼW*(b′) (2).

If the optimal objective value is negative (i.e., \tilde{W}*(b′)<0), the buyer would not assign any tasks under the bidding b′. Therefore, once tasks are assigned under b′, the expected payoff of the bidder j is non-negative when he is truthful.

### Theorem 3: Economic Efficiency

Truthful bidding maximizes the social welfare.

Proof: Truthful bidding is a best strategy for all the bidders by Theorem 1. Assume that c represents the truthful bidding (i.e., the bid price is the actual cost, c_{i,j}) of all the bidders. When every bidder is truthful, the optimal objective value becomes

$${W}^{*} ( c ) = {\sum }_{i = 1}^{t} {V}_{i} {P}_{i}^{*} ( c ) {p}_{i , {a}_{i}^{*} ( c )} - {\sum }_{i = 1}^{t} {c}_{i , {a}_{i}^{*} ( c )} {P}_{i}^{*} ( c ) .$$

Therefore, the optimal allocation maximizes the social welfare when all the bidders are truthful.

### Theorem 4: Equilibrium Payoff of Bidders and Buyer

Under the equilibrium of being truthful, the expected payoff of bidder j is XⱼW*(C) and the expected payoff of the buyer is (1−Σᵢ₌₁^{t}xᵢ)W*(c).

Proof: From equation (2) it can be seen that \tilde{W}ᵢ(c)=W*(c). Therefore, Uⱼ=XⱼW*(c) (see equation (1)). Accordingly, the buyer's expected payoff is

$$\begin{matrix}U = {\sum }_{i = 1}^{t} {V}_{i} {P}_{i}^{*} ( c ) {p}_{i , {a}_{i}^{*} ( c )} - {\sum }_{i = 1}^{t} ( {c}_{i , {a}_{i}^{*} ( c )} + {β}_{i , {a}_{i}^{*} ( c )} ) {P}_{i}^{*} ( c ) {p}_{i , {a}_{i}^{*} ( c )} \\ = {\sum }_{i = 1}^{t} {V}_{i} {P}_{i}^{*} ( c ) {p}_{i , {a}_{i}^{*} ( c )} - {\sum }_{i = 1}^{t} ( {x}_{i} {\tilde{W}}_{{a}_{i}^{*} ( c )} ( c ) + {c}_{i , {a}_{i}^{*} ( c )} ) {P}_{i}^{*} ( c ) \\ = {W}^{*} ( c ) - {\sum }_{i = 1}^{t} {x}_{i} W ( c ) \\ = ( 1 - {\sum }_{i = 1}^{t} ) {W}^{*} ( c ) .\end{matrix}$$

The Theorem 4 implies that when Σᵢ₌₁^{t}xᵢ<1, then the auction mechanism herein provides the non-negative expected pay off to the buyer (i.e., individual rationality is satisfied for the buyer).

### Theorem 5: Payment Bound of No Task Level Reserve Price

The value of the task for the buyer is V when all the sub-tasks are delivered with success and is zero otherwise under the no task level reserve price case. If all the sub-tasks are finished with success, the total payments to the suppliers including bonuses is not greater than V under the equilibrium of being truthful.

Proof: For notational simplicity, the truthful bidding c and the optimal assignment (aᵢ*(c)) are omitted in the following equations (i.e., W*(c)=W*, c_{i,a*}_{ᵢ}_{(c)}=c*ᵢ, etc.). Note that all the payments including bonuses are

$${\sum }_{i}^{ } \frac{{x}_{i} {W}^{*} + {c}_{i}^{*} {P}_{i}^{*}}{{p}_{i}^{*} {P}_{i}^{*}}$$

and W*=p*₁ . . . p*ₜV−Σᵢc*ᵢ*P*ᵢ*. Accordingly,

$${p}_{1}^{t} … {p}_{t}^{*} [ V - {\sum }_{i}^{ } \frac{{x}_{i} {W}^{*} + {c}_{i}^{*} {P}_{i}^{*}}{{p}_{i}^{*} {P}_{i}^{*}} ] = {W}^{*} + {\sum }_{i}^{ } {c}_{i}^{*} {P}_{i}^{*} - {\sum }_{t}^{ } ( {\prod }_{j ∉ \{ i , prec ( i ) \}}^{ } {p}_{j}^{*} ( {x}_{i} {W}^{*} + {c}_{i}^{*} {P}_{i}^{*} ) ) \geq C + {\sum }_{i}^{ } {c}_{i}^{*} {P}_{i}^{*} - {\sum }_{t}^{ } ( {x}_{i} {W}^{*} + {c}_{i}^{*} {P}_{i}^{*} ) = ( 1 - {\sum {x}_{i}}_{i} ) {W}^{*} \geq 0.$$

Therefore, the total payment

$${\sum }_{i}^{ } \frac{{x}_{i} {W}^{*} + {c}_{i}^{*} {P}_{i}^{*}}{{p}_{i}^{*} {P}_{i}^{*}} \leq V .$$

### Theorem 6: Payment Bound of Task Level Reserve Price

In this case, W*=Σᵢ(Vᵢp*ᵢ−c*ᵢ)P*ᵢ. If

$${x}_{i} \leq \frac{{V}_{i} {P}_{i}^{*} {p}_{i}^{*} - {c}_{i}^{*} {P}_{i}^{*}}{{W}^{*}} ,$$

then the total payments including bonuses when all sub-tasks are delivered with success is not more than Σᵢ Vᵢ. Note that because there is only allowed a bid price of bidder j for sᵢ less than Vᵢpᵢⱼ, it is possible to find a small positive number xᵢ.

Proof:

$$\begin{matrix}{\sum }_{i}^{ } {V}_{i} - {\sum }_{ i}^{ } \frac{{x}_{i} {W}^{*} + {c}_{i}^{*} {P}_{i}^{*}}{{p}_{i}^{*} {P}_{i}^{*}} = {\sum }_{i}^{ } \frac{{V}_{i} {p}_{i}^{*} {P}_{i}^{*} - {c}_{i}^{*} {P}_{i}^{*} - {x}_{i} {W}^{*}}{{p}_{i}^{*} {P}_{i}^{*}} \geq \\ {\sum }_{i}^{ } ( {V}_{i} {p}_{i}^{*} {P}_{i}^{*} - {c}_{i}^{*} {P}_{i}^{*} - {x}_{i} {W}^{*} ) \\ = ( 1 - {\sum }_{i = 1}^{t} ) {W}^{*} \geq 0.\end{matrix}$$

Therefore, the total payment

$${\sum }_{i}^{ } \frac{{x}_{i} {W}^{*} + {c}_{i}^{*} {P}_{i}^{*}}{{p}_{i}^{*} {P}_{i}^{*}} \leq {\sum }_{i}^{ } {V}_{i} .$$

B. Payment with Bonuses and Penalties

In this section, there is considered the more general case where penalties can be imposed as well as granting bonuses. The following shows all possible events for the payment including bonuses and penalties.

sᵢ is attempted and is successful, the supplier aᵢ*(b) receives the amount of c_{i,a*}_{ᵢ}_{(b)}+β_{i,a*}_{ᵢ}_{(b)} with probability P*ᵢ(b)·p_{i,a*}_{ᵢ}_{(b)}.

sᵢ is attempted and is unsuccessful, the supplier aᵢ*(b) does not receive any payment and is required to pay a penalty a_{i,a*}_{ᵢ}_{(b)} with probability P*ᵢ(b)·(1−p_{i,a*}_{ᵢ}_{(b)}).

sᵢ is not attempted, the supplier aᵢ*(b) does not receive any payment with probability 1−P*ᵢ*(b).

The buyer receives the incremental benefit Vᵢ when sᵢ is completed under the task level reserve price. However, the benefit is zero when sᵢ is not the final sub-task and it is V when sᵢ is the final sub-task and is successful under no task level reserve price.

### Lemma 2: Bonus and Penalty Function

If the bonus and penalty for sᵢ done by aᵢ*(b) satisfy the following equation, the expected payoff of aᵢ*(b) is xᵢ\tilde{W}_{a*}_{ᵢ}_{(b)}(b).

Proof:

$$\begin{matrix}{u}_{{a}_{i}^{*} ( b )} = {β}_{i , {a}_{i}^{*} ( b )} {P}_{i}^{*} ( b ) {p}_{i , {a}_{i}^{*} ( b )} - ( {α}_{i , {a}_{i}^{*} ( b )} + {c}_{i , {a}_{i}^{*} ( b )} ) ( 1 - {p}_{i , {a}_{i}^{*} ( b )} ) {P}_{i}^{*} ( b ) \\ = {x}_{i} {\tilde{W}}_{{a}_{i}^{*} ( b )} ( b ) + ( 1 - {p}_{i , {a}_{i}^{*} ( b )} ) ( {c}_{i , {a}_{i}^{*} ( b )} + {α}_{i , {a}_{i}^{*} ( b )} ) {P}_{i}^{*} ( b ) - \\ ( {a}_{i , {a}_{i}^{*} ( b )} + {c}_{i , {a}_{i}^{*} ( b )} ) ( 1 - {p}_{i , {a}_{i}^{*} ( b )} ) {P}_{i}^{*} ( b ) \\ = {x}_{i} {\tilde{W}}_{{a}_{i}^{*} ( b )} ( b ) .\end{matrix}$$

### Theorem 7: Incentive Compatibility

Being truthful is a best strategy for each bidder under the formulated assignment rule and payment rule with bonuses and penalties.

Proof: The proof is same as Theorem 1 by using Lemma 2.

### Theorem 8: Individual Rationality and Economic Efficiency

When the bidder is truthful, the expected payoff is non-negative. Truthful bidding maximizes the social welfare. Individual rationality and economic efficiency can be proved similarly as Theorem 2 and Theorem 3.

### Theorem 9: Equilibrium Payoff of the Bidder and the Buyer

In the equilibrium of being truthful, the expected payoff of bidder j is XⱼW*(c) and the expected payoff of the buyer is (1−Σᵢxᵢ)W*(c).

Proof: For the notational convenience, we let P*ᵢ(c)≡P*ᵢ and p_{i,a*}_{ᵢ}_{(c)}≡p*ᵢ and so on. Accordingly,

$$\begin{matrix}U = {\sum }_{i} {V}_{i} {P}_{i}^{*} {p}_{i}^{*} - {\sum }_{i} ( {c}_{i}^{*} + {β}_{i}^{*} ) {P}_{i}^{*} {p}_{i}^{*} + {\sum }_{i}^{ } {α}_{i} {P}_{i}^{*} ( 1 - {p}_{i}^{*} ) \\ = {\sum }_{i} {V}_{i} {P}_{i}^{*} {p}_{i}^{*} - {\sum }_{i} {c}_{i}^{*} {P}_{i}^{*} {p}_{i}^{*} - {\sum }_{i}^{ } {x}_{i} {W}^{*} + {c}_{i}^{*} ( 1 - {p}_{i}^{*} ) {P}_{i}^{*} \\ = {\sum }_{i} {V}_{i} {P}_{i}^{*} {p}_{i}^{*} - {\sum }_{i} {c}_{i}^{*} {P}_{i}^{*} - {\sum }_{i}^{ } {x}_{i} {W}^{*} \\ = ( 1 - {\sum }_{i} {x}_{i} ) {W}^{*} .\end{matrix}$$

### IV. CONCLUSION

As discussed herein, a fault tolerant combinatorial mechanism have been constructed which is applicable when there is execution uncertainty. The bidding languages for bidders and a buyer have been defined for a combinatorial auction for a task composed of multiple sub-tasks with time and precedence constraints. Under the described verification assumption that the buyer knows the actual cost of the supplier through investigation or auditing after the auction ends, a suitable winner determination problem and suitable payment rule including bonuses and penalties has been formulated. By leveraging the bonuses and penalties, the auction mechanism is made incentive compatible, individually rational, and economically efficient. The upper bounds for the total payment for a case of payment including bonuses has been derived, so there is a guarantee that the total payment is manageable. Additionally, the expected payoffs of all the bidders and the buyer has been derived under the equilibrium of being truthful.

With reference now to FIG. 3, there is shown an exemplary process, algorithm and/or method 100, e.g., carried out and/or executed by the system 10 and/or server 12 for administering and/or conducting a combinatorial auction as disclosed herein.

At step 110, a task, e.g., as described herein, is obtained. Suitably, the task is submitted and/or posted to the server 12 from the terminal 14 by a buyer, e.g., using the buyer bidding language described above. The submitted and/or posted task obtained may define one or more sub-tasks and a set of temporal and/or precedence relationships specified between the sub-tasks by the buyer or otherwise. The task may be further defined by a start time and end time corresponding to an interval in which the task (including its sub-tasks) are to be completed, and a set of valuations associated with the task and/or sub-tasks thereof.

At step 112, one or more bids are obtained associated with obtained task. Suitably, each bid is submitted and/or posted to the server 12 from a terminal 16 of one or more suppliers submitting the bids. In practice, each supplier may submit one or more bids, e.g., using the bidder bidding language described above. Each submitted bid suitably identifies a set of the sub-tasks for which the bid is being submitted. Additionally, each bid includes a proposed price for completing or delivering the individual sub-task in the identified set and a proposed schedule for starting and completing each individual sub-task in the identified set. In practice, the schedule may include a time range in which the bidder proposes to start each particular sub-task in the identified set. For example, the range may be identified and/or defined by a first or early start time and a second or later start time. The schedule may further include or define a duration in which the bidder proposes to complete the particular sub-task for which the schedule applies.

At step 114, one or more winning bids are determined and/or identified, e.g., by the processor 12 using the formulated winner determination problem as described herein. Suitably, the winning bids and/or identities of the suppliers submitting the same are returned to the buyer, e.g., to the buyer's terminal 14. In practice, the server 12 may access the BD 18 in order to obtain supplier rankings and/or ratings or other like data maintained therein, from which probabilities of suppliers successfully completing assigned sub-tasks may be derived by the server 12 in conjunction with solving the winner determination problem.

At step 116, verification of the completion, either successfully and/or unsuccessfully, of the sub-tasks assigned to and/or undertaken by the winning bidder therefor is obtained. Suitably, the buyer may submit and/or post such verification to the server 12, e.g., via the terminal 14.

At step 118, a payment amount due to each winning bidder is calculated and/or determined (e.g., by the server 12) for each sub-task, e.g., in accordance with the payment rule described herein, including any assessed bonus and/or penalty therefor. Suitably, for the purpose of assessing the payment amounts due and/or any bonuses and/or penalties, buyer discovers the true and/or actual cost of the winning bidders assigned sub-tasks, e.g., via investigation, auditing or otherwise, and submits and/or posts the same to the server 12, e.g., via the terminal 14. In practice, the determined payment amounts due to the respective suppliers, including any assessed bonuses and/or penalties, are returned to the buyer from the server 12, e.g., again via the terminal 14.

The above methods, algorithms, processes, systems and/or apparatus have been described with respect to particular embodiments. It is to be appreciated, however, that certain modifications and/or alteration are also contemplated.

For example, it is to be appreciated that in connection with the particular exemplary embodiment(s) presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that any one or more of the particular tasks, steps, processes, methods, algorithms, functions, elements and/or components described herein may suitably be implemented via hardware, software, firmware or a combination thereof. In particular, the processor 12 may be embodied by a computer or other electronic data processing device that is configured and/or otherwise provisioned to perform one or more of the tasks, steps, processes, methods and/or functions described herein. For example, a computer or other electronic data processing device embodying the processor 12 may be provided, supplied and/or programmed with a suitable listing of code (e.g., such as source code, interpretive code, object code, directly executable code, and so forth) or other like instructions or software or firmware, such that when run and/or executed by the computer or other electronic data processing device one or more of the tasks, steps, processes, methods and/or functions described herein are completed or otherwise performed. Suitably, the listing of code or other like instructions or software or firmware is implemented as and/or recorded, stored, contained or included in and/or on a non-transitory computer and/or machine readable storage medium or media so as to be providable to and/or executable by the computer or other electronic data processing device. For example, suitable storage mediums and/or media can include but are not limited to: floppy disks, flexible disks, hard disks, magnetic tape, or any other magnetic storage medium or media, CD-ROM, DVD, optical disks, or any other optical medium or media, a RAM, a ROM, a PROM, an EPROM, a FLASH-EPROM, or other memory or chip or cartridge, or any other tangible medium or media from which a computer or machine or electronic data processing device can read and use. In essence, as used herein, non-transitory computer-readable and/or machine-readable mediums and/or media comprise all computer-readable and/or machine-readable mediums and/or media except for a transitory, propagating signal.

Optionally, any one or more of the particular tasks, steps, processes, methods, functions, elements and/or components described herein may be implemented on and/or embodiment in one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the respective tasks, steps, processes, methods and/or functions described herein can be used.

Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method for conducting an auction comprising:
obtaining a task and a valuation therefor submitted by a buyer, said task being defined by a plurality of sub-tasks, a set of precedence relationships specified between the sub-tasks, and a designated start time for the task and a designated end time for the task corresponding to an interval in which the task is to be completed;
obtaining one or more bids associated with the task from one or more suppliers, each supplier submitting one or more of the bids and each bid identifying (i) a set of the sub-tasks for which the bid is being submitted, (ii) a proposed price for each individual sub-task in the identified set thereof and (iii) for each particular sub-task in the identified set, a schedule including a proposed start time range in which the supplier submitting the bid proposes to begin the particular sub-task in the identified set and a duration in which the supplier submitting the bid proposes to complete the particular sub-task;
determining a probability of each supplier successfully completing each sub-task for which they submitted a bid; and
identifying one or more winning bids from the obtained bids based on the proposed prices of the bids, the determined success probabilities and the proposed schedules of the bids, said winning bids satisfying constraints of the task.

2. The method of claim 1, said method further comprising:
determining payment amounts due to suppliers of winning bids for successful completion of sub-tasks.

3. The method of claim 2, wherein said payment amounts include determined bonuses for completion of sub-tasks.

4. The method of claim 3, wherein said payment amounts further include determined penalties for unsuccessful completion of sub-tasks.

5. The method of claim 2, wherein said payment amounts are determined based on actual costs of suppliers completing sub-tasks.

6. The method of claim 1, wherein no more than one bid from any given supplier is identified as one of the winning bids.

7. The method of claim 1, wherein at least one of the constraints is determined based on the precedence relationships specified between the sub-tasks.

8. A system for conducting an auction comprising:
a processor operative to:
obtain a task and a valuation therefor submitted by a buyer, said task being defined by a plurality of sub-tasks, a set of precedence relationships specified between the sub-tasks, a designated start time for the task and a designated end time for the task corresponding to an interval in which the task is to be completed;
obtain one or more bids associated with the task from one or more suppliers, each supplier submitting one or more of the bids and each bid identifying (i) a set of the sub-tasks for which the bid is being submitted, (ii) a proposed price for each individual sub-task in the identified set thereof and (iii) for each particular sub-task in the identified set, a schedule including a proposed start time range in which the supplier submitting the bid proposes to begin the particular sub-task in the identified set and a duration in which the supplier submitting the bid proposes to complete the particular sub-task;
determine a probability of each supplier successfully completing each sub-task for which they submitted a bid; and
identify one or more winning bids from the obtained bids based on the proposed prices of the bids, the determined success probabilities and the proposed schedules of the bids, said winning bids satisfying constraints of the task.

9. The system of claim 8, said processor further operative to:
determine payment amounts due to suppliers of winning bids for successful completion of sub-tasks.

10. The system of claim 9, wherein said payment amounts include bonuses determined by the processor for completion of sub-tasks.

11. The system of claim 10, wherein said payment amounts further include penalties determined by the processor for unsuccessful completion of sub-tasks.

12. The system of claim 9, wherein said payment amounts are determined by the processor based on actual costs of suppliers completing sub-tasks, which costs are obtained by the processor.

13. The system of claim 8, wherein no more than one bid from any given supplier is identified as one of the winning bids by the processor.

14. The system of claim 8, wherein at least one of the constraints is determined by the processor based on the precedence relationships specified between the sub-tasks.
